(19) United States
(12) Patent Application Publication
(10) Pub. No.: US 2004/0245169 A1
(43) Pub. Date: Dec. 9, 2004

(54) Filter element

(75) Inventor: Norbert Breusch, Sinsheim (DE)

Correspondence Address: LAW OFFICE OF BARRY R LIPSITZ, 755 MAIN STREET, MONROE, CT, 06468, US

(73) Assignee: ARGO-HYTOS GmbH, Kraichtal (DE)

(21) Appl. No.: 10/823,996

(22) Filed: Apr. 13, 2004

Related U.S. Application Data
(63) Continuation of application No. PCT/EP01/11922, filed on Oct. 16, 2001.

(51) Int. Cl. B01D 39/08

(52) U.S. Cl. 210/492; 210/483; 210/488; 210/499

(57) ABSTRACT

The invention relates to a filter element for fluids, in particular for hydraulic fluids, comprising a filter material and a grid-like supporting structure supporting the filter material at least on its outflow side in relation to the flow direction of the filter element. In order to further develop the filter element such that it has a high mechanical stability, whilst static charges are avoided, it is proposed in accordance with the invention that the supporting structure comprise elements made from a plastics material and electrically conductive elements.

The present disclosure relates to the subject matter disclosed in international application PCT/EP01/11922 of Oct. 16, 2001, which is incorporated herein by reference in its entirety and for all purposes.

### BACKGROUND OF THE INVENTION

The invention relates to a filter element for fluids, in particular for hydraulic fluids, comprising a filter material and a grid-like supporting structure supporting the filter material at least on its outflow side in relation to the flow direction of the filter element, with the supporting structure comprising elements made from a plastics material and electrically conductive elements.

Filter elements are known, for example, from WO 01/37969 A1 and U.S. Pat. No. 4,089,783. They are employed, in particular, in hydraulic systems such as used, for example, in automotive machines, for example, construction machines or agricultural machinery or in machine tools and processing machinery such as, for example, injection molding machines. The hydraulic systems must meet very high requirements as to purity of the hydraulic fluid so as to be able to fullfill their function over long periods of operation without malfunction and with low wear and tear. The hydraulic fluid flows through the filter element, and a pressure difference forms between the inflow side and the outflow side of the filter element. In order to withstand this pressure difference, the filter material is supported by the supporting structure. Depending on the operating method of the hydraulic system, the supporting structure is subjected to high load owing to the change in pressure, which may result in damage to the supporting structure.

A zinc-coated metal screen or a stainless steel fabric is normally used as supporting structure, but, in this case, a change in the volumetric rate of flow involves the risk of wire breakage. This may result in contamination of the hydraulic fluid. It has therefore already been proposed that the metal screen be replaced by a plastic fabric. It has, however, been found that use of a plastic fabric or of an extruded plastic netting can lead to static charges, which may cause damage to the hydraulic system, in particular, harm to the hydraulic fluid.

A filter material is known from utility model DE 200 13 839 U1, which comprises a supporting layer onto which a fiber fleece is nailed. The supporting layer is in the form of a woven fabric or thread composite with warp and weft threads arranged transversely to one another. Some of the threads are made of an electrically conductive material, preferably of metal, and form a grid, while the remaining threads of the supporting layer as well as the fiber fleece are made from a plastics material.

The object of the present invention is to develop a filter element of the kind mentioned of the outset in such a way that it has a high mechanical stability, whilst avoiding static charges.

### SUMMARY OF THE INVENTION

This object is accomplished in a filter element of the generic kind, in accordance with the invention, in that the supporting structure forms a supporting fabric comprising both metal threads and plastic threads, and in that filter material and the supporting fabric lie surface-to-surface against one another and are folded in a shape of a star, with the metal threads extending parallel to the pleats of the supporting fabric.

It has been found that by using elements made of a plastics material and electrically conductive elements for the supporting structure supporting the filter material, on the one hand, a high mechanical stability under reversed bending stresses can be achieved, and, on the other hand, static charges are reliably avoided. The mechanical stability under reversed bending stresses is ensured, in particular, by the use of the plastics material in the form of the plastic threads, which impart a high mechanical strength under reversed bending stresses to the supporting structure. Use of an electrically conductive material in the form of the metal threads ensures that electric charges can be discharged and, consequently, static charges are avoided.

In accordance with the invention, the plastics material and the metal material are interlaced. This imparts a particularly high mechanical stability under load to the supporting structure.

The filter material and the supporting fabric resting surface-to-surface thereagainst are folded in the shape of a star to form a pleated filter assembly. Provision is made in accordance with the invention for the metal threads to extend parallel to the pleats of the supporting fabric. During manufacture and use of the pleated filter assembly the metal threads are therefore not subjected to any considerable bending load. The service life of the filter element can thereby be considerably prolonged. The plastic threads extend at an incline or perpendicularly to the pleats of the supporting fabric. However, since the plastics material has a higher strength under reversed bending stresses than the metallic material, such an orientation of the plastic threads does not result in any relevant decrease in the mechanical stability of the supporting fabric.

It is advantageous for the warp threads of the supporting fabric to be made of plastic. The conductive metallic material can be used for weaving the weft threads, but plastic threads may also be used in addition thereto.

To improve the inflow and the outflow ratios of the filter element, it has proven expedient for the warp and weft threads of the supporting fabric to have different diameters. It is particularly advantageous for the diameter of the warp threads to be larger than the diameter of the weft threads.

The warp threads preferably have a diameter of from approximately 0.2 mm to approximately 0.3 mm. In particular, a diameter of from approximately 0.25 mm to approximately 0.26 mm has proven particularly favorable for the warp threads.

The weft threads preferably have a diameter of from approximately 0.1 mm to approximately 0.2 mm, with, in particular, a diameter of from approximately 0.12 mm to approximately 0.18 mm being advantageous.

In order to reliably support the filter material, on the one hand, and keep the pressure drop occurring as the fluid flows through the filter element as low as possible, on the other hand, a mesh width of from approximately 0.6 mm to approximately 1 mm has proven particularly favorable for the supporting fabric.

An iron material, for example, a zinc-coated iron material, may be used as electrically conductive material. It has proven particularly advantageous for the electrically conductive material to be a stainless steel.

A polyester material may, for example, be used as plastics material.

In particular, for use of a filter element as fine filter, it is advantageous for the filter material to be of multi-layer configuration. Provision may be made for the filter material to comprise a fine filter layer and a protective layer covering the fine filter layer at least on its outflow side. A fleece or cellulose paper may, for example, be used as fine filter layer. The protective layer covering the fine filter layer on its outflow side may likewise be in the form of a fleece. One or a plurality of prefilter layers may cover the fine filter layer on its inflow side. The prefilter layers may also be in the form of fleeces and/or cellulose papers.

To avoid mechanical damage to the filter material and—when configured as pleated filter assembly—to keep the pleats open, it is advantageous for the filter material to be covered on its inflow side by a screen-like protective fabric. Provision may be made for the above-described grid-like supporting structure, in particular the supporting fabric, to also be used as screen-like protective fabric.

The following description of a preferred embodiment of the invention serves in conjunction with the accompanying drawings to explain the invention in greater detail.

### BRIEF DESCRIPTION OF THE DRAWINGS

FIG. 1 is a perspective illustration of a filter element; and

FIG. 2 is an enlarged illustration of detail A from FIG. 1.

### DETAILED DESCRIPTION OF THE INVENTION

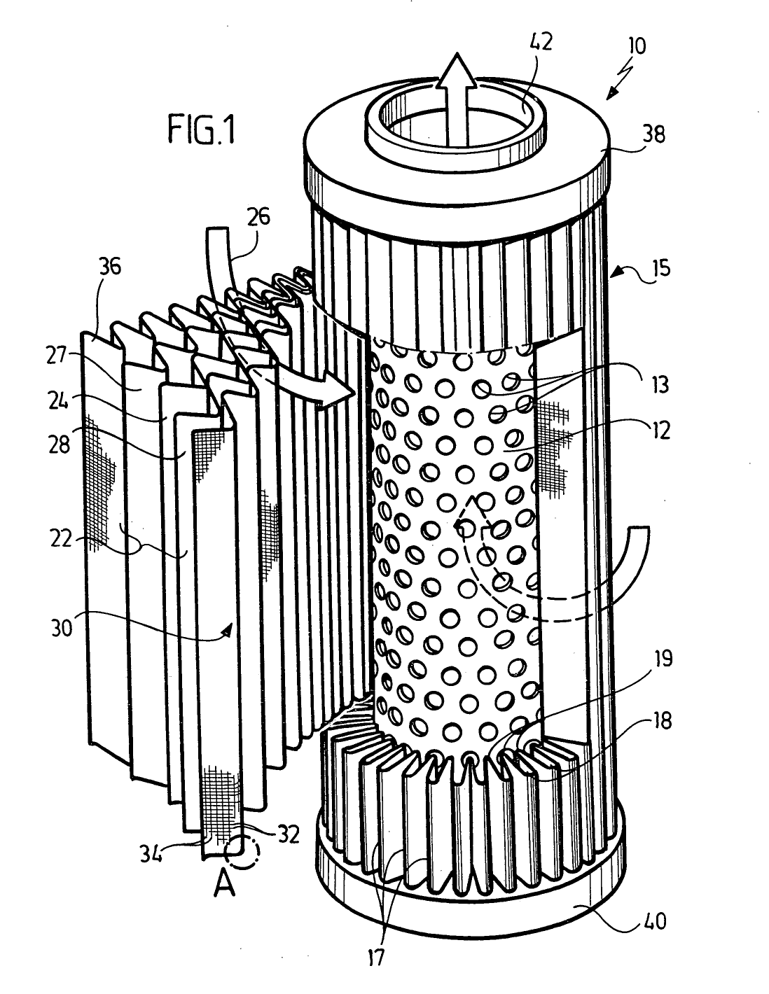

FIG. 1 shows schematically a filter element generally designated by the reference numeral 10. It comprises a cylindrical support tube 12 through which a multiplicity of perforations 13 extend in radial direction. The support tube 12 is surrounded in circumferential direction by a multi-layer pleated filter assembly 15, which for clarification purposes is shown in FIG. 1 partly in the form of an exploded drawing. Due to pleats 17 extending parallel to the longitudinal axis of the support tube 12, the pleated filter assembly 15 is folded in the shape of a star with radially outwardly lying pleat crests 18 and radially inwardly lying pleat roots 19 following one another alternately along its circumference.

The pleated filter assembly 15 comprises a three-layered filter material 22 with a fine filter layer in the form of a fleece 24 which in flow direction 26, i.e., in the illustrated embodiment in radial direction from the outside to the inside, is covered on its inflow side by a prefilter fleece 27 and on its outflow side by a protective fleece 28. The fleeces may, for example, be made from a plastics or glass fiber material.

In flow direction 26, the filter material 22 is supported on its outflow side on a supporting fabric 30 which lies surface-to-surface against the protective fleece 28 of the filter material 22 and is also folded in the shape of a star. The supporting fabric 30, in turn, is supported in flow direction 26 in the area of the pleat roots 19 on the support tube 12.

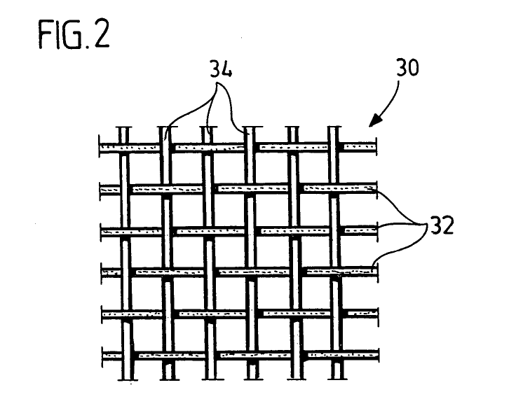

The structure of the supporting fabric 30 is shown in an enlarged view in FIG. 2. It is of screen-like or grid-like design and is formed by warp threads 32 made of plastics material and by weft threads 34 made of metal. Polyester is preferably used as plastics material, while the weft threads 34 are made from a rustproof metallic material, for example, stainless steel. The supporting fabric 30 is oriented such that the metallic weft threads 34 run parallel to the pleats 17, while the warp threads 32 made of plastic are aligned perpendicularly to the pleats 17. When folding the pleated filter assembly 15 and during filtration of the fluid, the metallic weft threads 34 are therefore subjected to virtually no bending load. By virtue of their use it is, however, ensured that electric charges occurring on account of charge isolating procedures within the filter material 22 can be discharged. This is important, above all, when the support tube 12 is made of plastic.

On its inflow side, the filter material 22 is covered by a screen-like protective fabric 36. A metal screen may, for example, be used therefor. Provision may, however, also be made for the protective fabric 36 to be of the same design as the supporting fabric 30 and to similarly comprise plastic threads and metal threads.

At its ends, the pleated filter assembly 15 is covered by an upper end cap 38 and a lower end cap 40, which are adhesively bonded to the pleated filter assembly 15. The lower end cap 40 forms a fluid-tight closure to the filter element 10, while the upper end cap 38 has a central outlet orifice 42.

The fluid to be filtered is supplied to the outside of the filter element 10, so that it can flow radially through the pleated filter assembly 15 from the outside inwards and pass through the perforations 13 into the interior of the support tube 12. The filtered fluid subsequently flows in the longitudinal direction of the support tube 12 to the outlet orifice 42 and through this out of the filter element 10 again. In order to keep the pressure drop in the flow of fluid occurring at the pleated filter assembly 15 as low as possible, it has proven advantageous for the warp and weft threads 32 and 34 to have different material strengths. A diameter of from approximately 0.25 mm to approximately 0.26 mm has proven particularly advantageous for the warp threads made of plastic, while a diameter of from approximately 0.15 mm to 0.17 mm is preferably provided for the metallic weft threads 34. The mesh width of the supporting fabric 30 is from approximately 0.6 mm to approximately 1.0 mm.

1. Filter element for fluids, in particular for hydraulic fluids, comprising a filter material, and a grid-like supporting structure supporting the filter material at least on its outflow side in relation to the flow direction of the filter element and having elements made of a plastics material and electrically conductive elements, wherein the supporting structure forms a supporting fabric comprising both metal threads and plastic threads, and the filter material and the supporting fabric lie surface-to-surface against one another and are folded in the shape of a star, with the metal threads extending parallel to the pleats of the supporting fabric.

2. Filter element in accordance with claim 1, wherein the warp threads of the supporting fabric are made of a plastics material.

3. Filter element in accordance with claim 1, wherein the weft threads of the supporting fabric are made of metal.

4. Filter element in accordance with claim 1, wherein the warp and weft threads of the supporting fabric have different diameters.

5. Filter element in accordance with claim 4, wherein the diameter of the warp threads is larger than the diameter of the weft threads.

6. Filter element in accordance with claim 4, wherein the warp threads have a diameter of from approximately 0.2 mm to approximately 0.3 mm.

7. Filter element in accordance with claim 4, wherein the weft threads have a diameter of from approximately 0.1 mm to approximately 0.2 mm.

8. Filter element in accordance with claim 1, wherein the supporting fabric has a mesh width of from approximately 0.6 mm to approximately 1.0 mm.

9. Filter element in accordance with claim 1, wherein the electrically conductive material is a stainless steel.

10. Filter element in accordance with claim 1, wherein the plastics material is a polyester material.

11. Filter element in accordance with claim 1, wherein the filter material comprises a fine filter layer, a protective layer covering the fine filter layer at least on its outflow side and/or a prefilter layer covering the fine filter layer on its inflow side.

12. Filter element in accordance with claim 1, wherein the filter material is covered on its inflow side by a screen-like protective fabric.
